(19) United States
(12) Patent Application Publication
(10) Pub. No.: US 2023/0383107 A1
(43) Pub. Date: Nov. 30, 2023

(54) POLYPROPYLENE COMPOSITION

(71) Applicant: Basell Poliolefine Italia S.r.l., Milan (IT)

(72) Inventors: Eleonora Ciaccia, Ferrara (IT); Marco Ciarafoni, Ferrara (IT); Caroline Cathelin, Ferrara (IT); Alberta De Capua, Ferrara (IT); Giansiro Prini, Ferrara (IT); Daniele Po, Ferrara (IT); Tiziana Caputo, Ferrara (IT); Roberto Pantaleoni, Ferrara (IT); Alessia Di Capua, Ferrara (IT)

(73) Assignee: Basell Poliolefine Italia S.r.l., Milan (IT)

(21) Appl. No.: 18/032,531

(22) PCT Filed: Oct. 6, 2021
(86) PCT No.: PCT/EP2021/077492

§ 371 Date: Apr. 18, 2023

(30) Foreign Application Priority Data
Oct. 19, 2020 (EP) 20202638.1

(51) Int. Cl. C08L 23/12

(52) U.S. Cl. CPC C08L 23/12; C08L 2205/025

(57) ABSTRACT

A polypropylene composition made from or containing:
A) from 76 wt % to 95 wt % of a propylene homopolymer having:
   fraction soluble in xylene at 25° C. between 2.0 wt % and 4.5 wt %; and
   melt flow rate ranging from 60.0 to 110.0 g/10 min; and
B) from 5 wt % to 24 wt % of a copolymer of propylene and ethylene containing from 75 wt % to 90.0 wt % of ethylene derived units;
wherein the polypropylene composition has
content of ethylene derived units in the fraction soluble in xylene at 25° C. lower than the content of ethylene derived units of component B) and ranging from 51.0 wt % to 74.0 wt %; and
at least two melting points, wherein the higher melting points ranges from 156.0° C. to 166.0° C. and the lower melting point ranges from 90.0° C. to 125.0° C.;
wherein the sum of the amounts of component A) and B) being 100 wt %.

### FIELD OF THE INVENTION

In general, the present disclosure relates to the field of chemistry. More specifically, the present disclosure relates to polymer chemistry. In particular, the present disclosure relates to polypropylene composition.

### BACKGROUND OF THE INVENTION

Isotactic polypropylene is useful for a variety of applications. In some instances, one or more copolymerization steps of one or more monomers improve properties resulting from the propylene stereoregular homopolymerization process.

### SUMMARY OF THE INVENTION

In a general embodiment, the present disclosure provides a polypropylene composition made from or containing:

A) from 76 wt % to 95 wt % of a propylene homopolymer having:
a fraction soluble in xylene at 25° C. between 2.0 wt % and 4.5 wt %, based upon the total weight of the propylene homopolymer; and
a melt flow rate (MFR L according to ISO 1133, condition L, that is, 230° C. and 2.16 kg load) ranging from 60.0 to 110.0 g/10 min; and

B) from 5 wt % to 24 wt % of a copolymer of propylene and ethylene containing from 75 wt % to 90.0 wt % of ethylene derived units, based upon the total weight of the copolymer;
wherein the polypropylene composition has
a xylene soluble fraction at 25° C. ranging from 6.8 wt % to 15.0 wt %, based upon the total weight of the polypropylene composition;
an intrinsic viscosity of the fraction soluble in xylene at 25° C. ranging from 0.5 dl/g to 1.5 dl/g;
a content of ethylene derived units in the fraction soluble in xylene at 25° C. lower than the content of ethylene derived units of component B) and ranging from 51.0 wt % to 74.0 wt %, based upon the total weight of the polypropylene composition;
at least two melting points, wherein the higher melting point ranges from 156.0° C. to 166.0° C. and the lower melting point ranges from 90.0° C. to 125.0° C.; and
a melt flow rate (MFR L according to ISO 1133, condition L, that is, 230° C. and 2.16 kg load) ranging from 45.0 to 110.0 g/10 min,
wherein the sum of the amounts of component A) and B) being 100 wt %.

### DETAILED DESCRIPTION OF THE INVENTION

In some embodiments, the present disclosure provides a polypropylene composition made from or containing:

A) from 76 wt % to 95 wt %; alternatively from 79 wt % to 91 wt %; alternatively from 82 wt % to 88 wt %, of a propylene homopolymer having:
a fraction soluble in xylene at 25° C. between 2.0 wt % and 4.5 wt %; alternatively from 2.5 wt % to 3.8 wt %; alternatively from 3.0 wt % to 3.6 wt %, based upon the total weight of the propylene homopolymer; and
a melt flow rate (MFR L according to ISO 1133, condition L, that is, 230° C. and 2.16 kg load) ranging from 60.0 to 110.0 g/10 min; alternatively from 71 g/10 min to 99 g/10 min; alternatively from 75 g/10 min to 89 g/10 min; and

B) from 5 wt % to 24 wt %, alternatively from 9 wt % to 21 wt %; alternatively from 12 wt % to 18 wt %; of a copolymer of propylene and ethylene containing from 75.0 wt % to 90.0 wt %, alternatively from 77.0 wt % to 88.0 wt %; alternatively from 79.0 wt % to 86.0 wt %; of ethylene derived units, based upon the total weight of the copolymer;
wherein the polypropylene composition has
a xylene soluble fraction at 25° C. ranging from 6.8 wt % to 15.0 wt %; alternatively from 7.0 wt % to 13.0 wt %; alternatively from 7.5 wt % to 11.0 wt %, based upon the total weight of the polypropylene composition;
an intrinsic viscosity of the fraction soluble in xylene at 25° C. ranging from 0.5 dl/g to 1.5 dl/g; alternatively from 0.7 dl/g to 1.3 dl/g; alternatively from 0.8 dl/g to 1.2 dl/g;
a content of ethylene derived units in the fraction soluble in xylene at 25° C. lower than the content of ethylene derived units of component B) and ranging from 51.0 wt % to 74.0 wt %, alternatively from 55.0 wt % to 71 wt %; alternatively from 58.0 wt % to 67.0 wt %, based upon the total weight of the polypropylene composition;
at least two melting points, wherein the higher melting point ranges from 156.0° C. to 166.0° C.; alternatively ranging from 158.0° C. to 165.0° C.; alternatively ranging from 159.0° C. to 165° C.; and the lower melting point ranges from 90.0° C. to 125.0° C., alternatively from 100.0° C. to 120.0° C.; alternatively from 104.0° C. and 117.0° C.; and
a melt flow rate (MFR L according to ISO 1133, condition L, that is, 230° C. and 2.16 kg load) ranging from 45.0 to 110.0 g/10 min; alternatively from 50 g/10 min to 90 g/10 min; alternatively from 58 g/10 min to 85 g/10 min,
wherein the sum of the amounts of component A) and B) being 100 wt %.

As used herein, the term “copolymer” refers to a polymer containing two kinds of monomers. In some embodiments, the monomers are propylene and ethylene.

In some embodiments, the polypropylene composition is used for molding as articles, alternatively injection molding articles, alternatively thin-walled-inj ection-molding (TWIM) articles.

In some embodiments, the ratio between the tensile modulus and the haze measured on 1 mm plaque is higher than 60, alternatively higher than 68, alternatively higher than 72.

In some embodiments, the polypropylene composition is produced by sequential polymerization in at least two stages, with each subsequent polymerization stage being conducted in the presence of the polymeric material formed in the immediately preceding polymerization reaction. In some embodiments, the component (A) is prepared in at least one first polymerization stage. In some embodiments, the component (B) is prepared in at least one second polymerization stage.

In some embodiments, the polymerization process is carried out in gas phase or in liquid phase, in continuous or batch reactors, such as fluidized bed or slurry reactors. In some embodiments, the polymerization of the propylene polymer (A) is carried out in liquid phase, using liquid propylene as diluent, while the copolymerization stage to obtain the propylene copolymer fraction (B) is carried out in gas phase, without intermediate stages except for the partial degassing of the monomers. In some embodiments, the sequential polymerization stages are carried out in gas phase. In some embodiments, the temperature for the preparation of fraction (A) and (B), are the same or different and from 50° C. to 120° C. In some embodiments, the polymerization pressure ranges from 0.5 to 12 MPa and the polymerization is carried out in gas-phase. In some embodiments, the catalytic system is pre-contacted (pre-polymerized) with small amounts of olefins. In some embodiments, the molecular weight of the propylene polymer composition is regulated. In some embodiments, the molecular weight regulator is hydrogen.

In some embodiments and in the second stage of the polymerization process, the propylene/ethylene copolymer (B) is produced in a fluidized-bed gas-phase reactor in the presence of the polymeric material and the catalyst system coming from the preceding polymerization step. In some embodiments, the propylene polymer compositions are obtained by separately preparing the copolymers (A) and (B), operating with the same catalysts and under the same polymerization conditions as previously illustrated, and mechanically blending the copolymers in the molten state. In some embodiments, the blending occurs in twin-screw extruders.

In some embodiments, each polymerization stage is carried out in presence of a highly stereospecific heterogeneous Ziegler-Natta catalyst. In some embodiments, the Ziegler-Natta catalysts are made from or containing a solid catalyst component made from or containing a titanium compound having a titanium-halogen bond and an electron-donor compound (internal donor), both supported on magnesium chloride. In some embodiments, the Ziegler-Natta catalysts systems are further made from or containing an organo-aluminum compound as a co-catalyst and optionally an external electron-donor compound.

In some embodiments, the catalysts systems are as described in the European Patent Nos. EP45977, EP361494, EP728769, and EP 1272533 and Patent Cooperation Treaty Publication No. W000163261.

In some embodiments, the polypropylene composition is obtained by polymerizing propylene and ethylene in various stages in the presence of a catalyst system made from or containing the product obtained by contacting the following components:
a) a solid catalyst component made from or containing a magnesium halide, a titanium compound having a Ti-halogen bond and an electron donor compound selected from succinates,
b) an aluminum hydrocarbyl compound, and
c) optionally an external electron donor compound.

In some embodiments and in the solid catalyst component (a), the succinate is selected from succinates of formula (I)

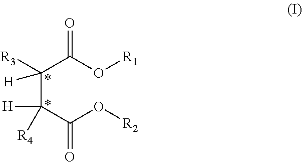

wherein the radicals R₁ and R2, equal to, or different from, each other are a C₁-C₂₀ linear or branched alkyl, alkenyl, cycloalkyl, aryl, arylalkyl or alkylaryl group, optionally containing heteroatoms; and the radicals R₃ and R₄ equal to, or different from, each other, are C₁-C₂₀ alkyl, C₃-C₂₀ cycloalkyl, C₅-C₂₀ aryl, arylalkyl or alkylaryl group with the proviso that at least one of the radicals R₃ and R₄ is a branched alkyl; the compounds being, with respect to the two asymmetric carbon atoms identified in the structure of formula (I), stereoisomers of the type (S,R) or (R,S)

In some embodiments, R₁ and R₂ are selected from the group consisting of C₁-C₈ alkyl, cycloalkyl, aryl, arylalkyl and alkylaryl groups. In some embodiments, R₁ and R₂ are selected from primary alkyls, alternatively branched primary alkyls. In some embodiments, R₁ and R₂ groups are selected from the group consisting of methyl, ethyl, n-propyl, n-butyl, isobutyl, neopentyl, and 2-ethylhexyl. In some embodiment, R₁ and R₂ groups are selected from the group consisting of ethyl, isobutyl, and neopentyl.

In some embodiments, the R₃ or R₄ radicals are secondary alkyls or cycloakyls. In some embodiments, the secondary alkyls are selected from the group consisting of isopropyl, sec-butyl, 2-pentyl, and 3-pentyl. In some embodiments, the cycloakyls are selected from the group consisting of cyclohexyl, cyclopentyl, and cyclohexylmethyl.

In some embodiments, the compounds are pure or in mixture, optionally in racemic form, of diethyl 2,3-bis(trimethylsilyl)succinate, diethyl 2,3-bis(2-ethylbutyl)succinate, diethyl 2,3-dibenzylsuccinate, diethyl 2,3-diisopropylsuccinate, diisobutyl 2,3-diisopropyl succinate, diethyl 2,3-bis(cyclohexylmethyl)succinate, diethyl 2,3-diisobutylsuccinate, diethyl 2,3-dineopentyl succinate, diethyl 2,3-dicyclopentyl succinate, and diethyl 2,3-dicyclohexyl succinate.

In some embodiments, the magnesium halide is MgCl₂ in active form. In some embodiments, the magnesium halide is as described in U.S. Pat. Nos. 4,298,718 and 4,495,338. In some embodiments, the magnesium halide is selected from magnesium dihalides in active form and used as a support or co-support in components of catalysts for the polymerization of olefins.

In some embodiments, the titanium compounds are selected from the group consisting of TiCl₄ and TiCl₃. In some embodiments, the titanium compounds are Ti-haloalcoholates of formula Ti(OR)_{n-y}X_{y}, where n is the valence of titanium, y is a number between 1 and n-1, X is halogen, and R is a hydrocarbon radical having from 1 to 10 carbon atoms.

In some embodiments, the catalyst component (a) has an average particle size ranging from 15 to 80 μm, alternatively from 20 to 70 μm, alternatively from 25 to 65 μm.

In some embodiments, the alkyl-A1 compound (b) is selected from the group consisting of trialkyl aluminum compounds. In some embodiments, the trialkyl aluminum compounds are selected from the group consisting of triethylaluminum, tri-n-hexylaluminum, and tri-n-octylaluminum. In some embodiments, trialkylaluminums are used in mixtures with alkylaluminum halides, alkylaluminum hydrides or alkylaluminum sesquichlorides. In some embodiments, the alkylaluminum sesquichloride is selected from the group consisting of as AlEt₂Cl and Al₂Et₃Cl₃.

In some embodiments, the external electron-donor compounds include silicon compounds, ethers, esters, amines, heterocyclic compounds, ketones and 1,3-diethers. In some embodiments, the external electron-donor compound is selected from the group consisting of ethyl 4- ethoxybenzoate and 2,2,6,6-tetramethyl piperidine. In some embodiments, the external donor compounds are silicon compounds of formula Rₐ⁵R_{b}⁶Si(OR⁷)_{c}, where a and b are integer from 0 to 2, c is an integer from 1 to 3 and the sum (a+b+c) is 4; R⁵, R⁶, and R⁷ are alkyl, cycloalkyl or aryl radicals with 1-18 carbon atoms optionally containing heteroatoms. In some embodiments, the external donor compounds are selected from the group consisting of methylcyclohexyldimethoxysilane, diphenyldimethoxysilane, methyl-t-butyldimethoxysilane, dicyclopentyldimethoxysilane, 2-ethylpiperidinyl-2-t-butyldimethoxysilane, 1,1,1,trifluoropropyl-2-ethylpiperidinyl-dimethoxysilane, and 1,1,1,trifluoropropyl-metil-dimethoxysilane. In some embodiments, the external electron donor compound is used in such an amount to give a molar ratio between the organo-aluminum compound and the electron donor compound of from 5 to 500, alternatively from 5 to 400, alternatively from 10 to 200.

In some embodiments, the catalyst forming components are contacted with a liquid inert hydrocarbon solvent at a temperature below about 60° C., alternatively from about 0 to 30° C., for from about 6 seconds to 60 minutes. In some embodiments, the liquid inert hydrocarbon solvent is propane, n-hexane, or n-heptane.

In some embodiments, the catalyst components (a), (b) and optionally (c) are fed to a pre-contacting vessel, in amounts such that the weight ratio (b)/(a) is in the range of 0.1-10. In some embodiments, the compound (c) is present and the weight ratio (b)/(c) corresponds to the molar ratio defined above. In some embodiments, the components are pre-contacted at a temperature of from 10 to 20° C. for 1-30 minutes. In some embodiments, the precontact vessel is a stirred tank reactor.

In some embodiments, the precontacted catalyst is then fed to a prepolymerization reactor where a prepolymerization step takes place. In some embodiments, the prepolymerization step is carried out in a first reactor selected from a loop reactor or a continuously stirred tank reactor. In some embodiments, the prepolymerization step is carried out in liquid-phase. The liquid medium is made from or containing liquid alpha-olefin monomer(s), optionally with the addition of an inert hydrocarbon solvent. In some embodiments, the hydrocarbon solvent is aromatic or aliphatic. In some embodiments, the aromatic hydrocarbon solvent is toluene. In some embodiments, the aliphatic hydrocarbon solvent is selected from the group consisting of propane, hexane, heptane, isobutane, cyclohexane, and 2,2,4-trimethylpentane. In some embodiments, the amount of hydrocarbon solvent is lower than 40% by weight with respect to the total amount of alpha-olefins, alternatively lower than 20% by weight. In some embodiments, step (a) is carried out in the absence of inert hydrocarbon solvents.

In some embodiments, the average residence time in this reactor ranges from 2 to 40 minutes, alternatively from 10 to 25 minutes. In some embodiments, the temperature ranges between 10° C. and 50° C., alternatively between 15° C. and 35° C. In some embodiments, the resulting pre-polymerization degree was in the range from 60 to 800 g per gram of solid catalyst component, alternatively from 150 to 500 g per gram of solid catalyst component. In some embodiments, step (a) is further characterized by a low concentration of solid in the slurry. In some embodiments, the concentration of solid in the slurry is in the range from 50 g to 300 g of solid per liter of slurry.

In some embodiments, the polypropylene composition is further made from or containing additives. In some embodiments, the additives are selected from the group consisting of antioxidants, light stabilizers, nucleating agents, antiacids, colorants and fillers.

In some embodiments, the polypropylene composition is used for producing injection-molded articles.

The following examples are given to illustrate and not to limit the present disclosure.

### EXAMPLES

The data of the propylene polymer materials were obtained according to the following methods:

Melt Flow Rate

Determined according to ISO 1133 (230° C., 2.16 kg).

Determination of Ethylene (C2) Content by NMR

¹³C NMR spectra were acquired on a Bruker AV-600 spectrometer equipped with cryoprobe, operating at 160.91 MHz in the Fourier transform mode at 120° C. The ethylene content was measured on the total composition. The ethylene content of component B) was calculated using the amount of component B), according to the following equation:

C₂ₜₒₜ=C_{2B}X wt % compB/100

The samples were dissolved in 1,1,2,2-tetrachloroethane-d2 at 120° C. with an 8% wt/v concentration. Each spectrum was acquired with a 90° pulse, 15 seconds of delay between pulses and CPD, thereby removing ¹H-¹³C coupling. 512 transients were stored in 32K data points using a spectral window of 9000 Hz.

The peak of the Sββ carbon (nomenclature according to “Monomer Sequence Distribution in Ethylene-Propylene Rubber Measured by ¹³C NMR. 3. Use of Reaction Probability Mode ” C. J. Carman, R. A. Harrington and C. E. Wilkes, Macromolecules, 1977, 10, 536) was used as an internal standard at 29.9 ppm. The samples were dissolved in 1,1,2,2-tetrachloroethane-d2 at 120° C. with an 8% wt/v concentration. Each spectrum was acquired with a 90° pulse, and 15 seconds of delay between pulses and CPD, thereby removing ¹H-¹³C coupling. 512 transients were stored in 32K data points using a spectral window of 9000 Hz.

The assignments of the spectra, the evaluation of triad distribution, and the composition were made according to Kakugo (“Carbon-13 NMR determination of monomer sequence distribution in ethylene-propylene copolymers prepared with 6-titanium trichloride-diethylaluminum chloride” M. Kakugo, Y. Naito, K. Mizunuma and T. Miyatake, Macromolecules, 1982, 15, 1150) using the following equations:

$$\begin{matrix}PPP = 100 T ββ / S & PPE = 100 T βδ / S & EPE = 100 T δδ / S \\ PEP = 100 S ββ / S & PEE = 100 S βδ / S & EEE = 100 ( 0.25 S γδ + 0.5 S δδ ) / S\end{matrix}$$

$$S = T ββ + T βδ + T δδ + S ββ + S βδ + 0.25 S γδ + 0.5 S δδ$$

The molar percentage of ethylene content was evaluated using the following equation:

E % mol=100*[PEP+PEE+EEE]

The weight percentage of ethylene content was calculated using the following equation:

E % mol*MWE

E % wt.=E % mol*MWE+P % mol*MWP

where P % mol was the molar percentage of propylene content while MWE and MWP were the molecular weights of ethylene and propylene, respectively.

The product of reactivity ratio r1r2 was calculated according to Carman (C. J. Carman, R. A. Harrington and C. E. Wilkes, Macromolecules, 1977; 10, 536) as:

$${r}_{1} {r}_{2} = 1 + ( \frac{E E E + P E E}{P E P} + 1 ) - ( \frac{P}{E} + 1 ) {( \frac{E E E + P E E}{P E P} + 1 )}^{0.5}$$

The tacticity of propylene sequences was calculated as mm content from the ratio of the PPP mmT_{ββ} (28.90-29.65 ppm) and the whole Tpp (29.80-28.37 ppm).

The ethylene content of component B) was calculated from the total ethylene content by using the following equation:

E % wt total=E % wt/B*wt % B

wherein E % wt total was the total ethylene content, E % wt/B was the ethylene content of component B). and wt % B was the amount (wt %/100) of component B).

Molar Ratios of the Feed Gases

Determined by gas-chromatography.

Samples for the Mechanical Analysis

Samples were obtained according to ISO 294-2

Flexural Modulus

Determined according to ISO 178.

Melting Temperature, Melting Enthalpy and Crystallization Temperature

Determined according to ISO 11357-3, at scanning rate of 20C/min both in cooling and heating, on a sample of weight between 5 and 7 mg. under inert N2 flow. Instrument calibration made with Indium.

Xylene Soluble and Insoluble Fractions at 25° C. (Room Temperature)

Xylene Solubles according to ISO 16 152; with solution volume of 250 ml, precipitation at 25° C. for 20 minutes, 10 minutes of which with the solution in agitation (magnetic stirrer), and dried at 70° C. under vacuum.

Intrinsic Viscosity (I.V.)

The sample was dissolved by tetrahydronaphthalene at 135° C. and then poured into the capillary viscometer.

The viscometer tube (Ubbelohde type) was surrounded by a cylindrical glass jacket. The setup allowed temperature control with a circulating thermostatic liquid.

The downward passage of the meniscus was timed by a photoelectric device. The passage of the meniscus in front of the upper lamp started the counter which had a quartz crystal oscillator. The counter stopped as the meniscus passed the lower lamp. The efflux time was registered and converted into a value of intrinsic viscosity.

Charpy Impact Strength

Charpy impact test according to ISO 179-1eA, e ISO 1873-2

Haze (on 1 mm Plaque)

5×5 cm specimens were cut, molded plaques of 1 mm thick. The haze value was measured using a Gardner photometric unit connected to a Hazemeter type UX-10 or an equivalent instrument having G.E. 1209 light source with filter “C”. Haze standards were used for calibrating the instrument. The test plaques were produced according to the following method.

75×75×1 mm plaques were molded with a GBF Plastinjector G235190 Injection Molding Machine, 90 tons under the following processing conditions:
Screw rotation speed: 120 rpm
Back pressure: 10 bar
Melt temperature: 260° C.
Injection time: 5 sec
Switch to hold pressure: 50 bar
First stage hold pressure: 30 bar
Second stage pressure: 20 bar
Hold pressure profile: First stage 5 sec
Second stage 10 sec
Cooling time: 20 sec
Mold water temperature: 40° C.

### Example 1

Catalyst System

The Ziegler-Natta catalyst was prepared according to Example 5, lines 48-55 of the European Patent No. EP728769. Triethylaluminum (TEAL) was used as co-catalyst, and dicyclopentyldimethoxysilane (DCPMS) was used as external donor, with the weight ratios indicated in Table 1.

Prepolymerization Treatment

Before introducing the solid catalyst component into the first polymerization reactor, the solid catalyst component was subjected to prepolymerization by suspending the solid catalyst component in liquid propylene at 20° C. for about 5 minutes.

Polymerization

The polymerization run was conducted in continuous mode in a series of three reactors equipped with devices to transfer the product from each reactor to the next reactor. The first two reactors were liquid phase reactors, and the third reactor was a fluid bed gas phase reactor. Component (A) was prepared in the first and second reactors while component (B) was prepared in the third reactor.

Hydrogen was used as molecular weight regulator.

The gas phase (propylene, ethylene, and hydrogen) was continuously analyzed via gas-chromatography.

At the end of the run, the powder was discharged and dried under a nitrogen flow.

The main polymerization conditions are reported in Table 1.

TABLE 1

| | | Ex. 1 |
|---|---|---|
| TEAL/solid catalyst component | | 9.3 |
| weight ratio | | |
| TEAL/DCPMS weight ratio | | 10 |
| Liquid phase reactors | | |
| Polymerization temperature | ° C. | 70 |
| Pressure | Bar-g | 38 |
| Residence time | minutes | 46 |
| H2 feed | molppm | 5839 |
| 1st gas phase reactor | | |
| Polymerization temperature | ° C. | 80 |
| Pressure | Barg | 13 |
| Residence time | min | 58 |
| C2/(C2 + C3) | Mol ratio | 0.705 |
| H2/C2 | Mol ratio | 0.592 |

C2 = ethylene;
C3 = propylene;
H2 = hydrogen

The polymers features are reported in Table 2.

TABLE 2

| Example | | Ex1 | Comp ex 2 |
|---|---|---|---|
| Component a) | | | |
| t | wt % | 85 | 85 |
| Ethylene content | wt % | 0 | 3.2 |
| MFR | g/10′ | 81 | 20 |
| Xylene soluble at 25° C. | wt % | 3.2 | 6 |
| Component b) | | | |
| split | wt % | 15 | 15 |
| Ethylene content in component b) | wt % | 82 | 80 |
| Property of the composition | | | |
| Xylene soluble at 25° C. | wt % | 13.7 | — |
| MFR | g/10′ | 64 | — |
| XSIV (intrinsic viscosity of XS) | dl/g | 1.05 | 1.2 |
| Ethylene content on the xylene | Wt % | 64.4 | — |
| soluble fraction | | | |
| Tensile Modulus | MPa | 1950 | 990 |
| Haze (1 mm plaque) | % | 25 | 16.4 |
| Melting temperature | ° C. | 163.3-110.9 | — |

Comparative example 2 is example 1 of Patent Cooperation Treaty Publication No. WO 2011/045194, wherein the tensile modulus was reported.

1. A polypropylene composition comprising:
A) from 76 wt % to 95 wt % of a propylene homopolymer having:
a fraction soluble in xylene at 25° C. between 2.0 wt % and 4.5 wt % based upon the total weight of the propylene homopolymer; and
a melt flow rate (MFR L according to ISO 1133, condition L, that is, 230° C. and 2.16 kg load) ranging from 60.0 to 110.0 g/10 min; and
B) from 5 wt % to 24 wt % of a copolymer of propylene and ethylene containing from 75 wt % to 90.0 wt % of ethylene derived units, based upon the total weight of the copolymer;
wherein the polypropylene composition has
a xylene soluble fraction at 25° C. ranging from 6.8 wt % to 15.0 wt %, based upon the total weight of the polypropylene composition;
an intrinsic viscosity of the fraction soluble in xylene at 25° C. ranging from 0.5 dl/g to 1.5 dl/g;
a content of ethylene derived units in the fraction soluble in xylene at 25° C. lower than the content of ethylene derived units of component B) and ranging from 51.0 wt % to 74.0 wt %, based upon the total weight of the polypropylene composition;
at least two melting points, wherein the higher melting point ranges from 156.0° C. to 166.0° C. and the lower melting point ranges from 90.0° C. to 125.0° C.; and
a melt flow rate (MFR L according to ISO 1133, condition L, that is 230° C. and 2.16 kg load) ranging from 45.0 to 110.0 g/10 min,
wherein the sum of the amounts of component A) and B) being 100 wt %.

2. The polypropylene composition according to claim 1, wherein, in component (A), the fraction soluble in xylene at 25° C. is between 2.5 wt % to 3.8 wt %, based upon the total weight of the propylene homopolymer.

3. The polypropylene composition according to claim 1, wherein component B) contains from 77.0 wt % to 88.0 wt % of ethylene derived units, based upon the total weight of the copolymer.

4. The polypropylene composition according to claim 1, wherein the xylene soluble fraction at 25° C. ranges from 7.0 wt % to 13.0 wt %, based upon the total weight of the polypropylene composition.

5. The polypropylene composition according to claim 1, wherein the intrinsic viscosity of the fraction soluble in xylene at 25° C. ranges from 0.7 dl/g to 1.3 dl/g.

6. The polypropylene composition according to claim 1, wherein the polypropylene composition has at least two melting points, wherein the higher melting point ranges from 158.0° C. to 165.0° C. and the lower melting point ranges from 100.0° C. to 120.0° C.

7. The polypropylene composition according to claim 1, wherein the content of ethylene derived units in the fraction soluble in xylene at 25° C. is lower than the content of ethylene derived units of component B) and ranges from 55.0 wt % to 71 wt %, based upon the total weight of the polypropylene composition.

8. The polypropylene composition according to claim 1, wherein the melt flow rate (MFR L according to ISO 1133, condition L, that is, 230° C. and 2.16 kg load) ranges from 50 g/10 min to 90 g/10 min.

9. The polypropylene composition according to claim 1, wherein component A) ranges from 79 wt % to 81 wt % and component B) ranges from 9 wt % to 21 wt %.

10. The polypropylene composition according to claim 1, wherein component A) ranges from 82 wt % to 88 wt % and component B) ranges from 12 wt % to 18 %.

11. The polypropylene composition according to claim 1, wherein component B) contains from 79.0 wt % to 86.0 wt % of ethylene derived units, based upon the total weight of the copolymer.

12. The polypropylene composition according to claim 1, wherein the xylene soluble fraction at 25° C. ranges from 7.5 wt % to 11.0 wt %, based upon the total weight of the polypropylene composition.

13. The polypropylene composition according to claim 1, wherein the content of ethylene derived units in the fraction soluble in xylene at 25° C. is lower than the content of ethylene derived units of component B) and ranges from 58.0 wt % to 67 wt %, based upon the total weight of the polypropylene composition.

14. The polypropylene composition according to claim 1, wherein the polypropylene composition has at least two melting points, wherein the higher melting point ranges from 159.0° C. to 165.0° C. and the lower melting point ranges from 104.0° C. to 117.0° C.

15. An injection molded article comprising the polypropylene composition of claim 1.
